(19) United States
(12) Patent Application Publication
(10) Pub. No.: US 2013/0004078 A1
(43) Pub. Date: Jan. 3, 2013

(54) DOCUMENT MANAGEMENT SYSTEM, EVALUATION DEVICE, DATA OUTPUT CONTROL DEVICE, DOCUMENT MANAGEMENT METHOD AND DOCUMENT MANAGEMENT PROGRAM

(75) Inventors: Shingo Miyazaki, Tokyo (JP); Makoto Akimoto, Tokyo (JP); Tatsuro Ikeda, Tokyo (JP); Tomoaki Morijiri, Tokyo (JP); Toshio Okamoto, Tokyo (JP)

(73) Assignees: TOSHIBA SOLUTIONS CORPORATION, Tokyo (JP); Kabushiki Kaisha Toshiba, Tokyo (JP)

(21) Appl. No.: 13/635,106

(22) PCT Filed: Mar. 31, 2011
(86) PCT No.: PCT/JP11/58191

§ 371 Date: Sep. 14, 2012

(30) Foreign Application Priority Data
Mar. 31, 2010 (JP) 2010-081315

(51) Int. Cl. G06F 21/24; G06K 9/18

(52) U.S. Cl. 382/182; 726/1

(57) ABSTRACT

According to one embodiment, a document management system in the embodiments, includes an information acquisition unit that acquires a management ID, acquires, using the management ID, document type information, and outputs the document type information. The document management system in the embodiments of the invention, includes a policy selection evaluation unit that acquires operation information, user information, and the document type information, selects policy information defining an operation extent of user based on the document type information, and evaluates whether or not that a user defined in the user information is authorized to perform an operation defined in the operation information in accordance with a definition of the selected policy information.

### CROSS REFERENCE TO RELATED APPLICATION

This application is based upon and claims the benefit of propriety from Japanese Patent Application Number 2010-81315, filed Mar. 31, 2010 and PCT Application No. PCT/JP2011/58191, filed Mar. 31, 2011 the entire contents of which are incorporated herein by reference.

### FIELD

Embodiments described herein relate generally to a technique for converting a paper document to an electronic formant to store it as an original document data and managing operations of the original document data such as viewing it or replicating to electronic information or a paper.

### BACKGROUND

The need to promote the work restructuring for restructuring work process corresponding to the reinforcement for various regulations such as Financial Instruments and Exchange Law becomes urgent. While start points of a lot of information is volumes of documentation that is not permitted to be disposed at once (for example, ledger sheets, documents, and a paper medium where information is described), the disposal of document is ranked as a most important management issue. In order to solve the issue, it is necessary to provide a filing system (digital storage) for efficiently and securely digitizing documents in all processing such as contracting and applying and storing large quantities of data including image data.

The digitization of a large amount of contract information and client information allows to assure and streamline the correspondence of storage and management of all contract data including image data. That also allows to provide the effects such as the business cost reduction, the implementation of the environment management (electric power saving, CO₂ reduction).

The compliance covers not only an original document but also the duplications derived from the original document. Especially, the event associated with the client information leakage should never happen in financial institutions under the overseeing by the Financial Services Agency, and it is necessary to clarify the how and the route of it even if the event occurs. Consequently, it is basic and most important issue on the compliance reinforcement to manage the access authorization for data including provided personal information and the traceability.

Since the filing system including a large amount of data is accessed via multi channels, the accesses, the searching and data providing of data including the client information occur in every day. Therefore, it is very important to protect the data access authorization management and data providing in view point of the client information protection.

Moreover, regardless of the contract services, since the “paperless” is promoted in the general office, it is important to protect data output from the common Database (DB) server and the Multifunction Peripheral (MFP: digital complex device). In the general office, it is basic and most important issue on the compliance reinforcement to manage the access authorization for data and the traceability in the same case as the contract management services.

The conventional system will be described by reference to FIG. 21. The conventional system needs to set a rule (policy) associated with the restriction of dealing with document such as the authorization of referring, duplicating and correcting, for each document. In the case of that, the time and effort for the setting such as creating a policy corresponding to each document, and errors increase in proportion to a large amount of documents. In the background art, the policy management may become complex in accordance with the number of documents, and moreover, the processing load of device such as the data reference processing increases in proportion to the number of policies.

In actual business activity, since the compliance for the client information, the important rules, the articles and the contract information is required, information needed to be strictly managed for dealing is flooded in and out of the office. The information undergoes the duplication operation such as the electronic copying, the printing, the duplicating and the image scanning if necessary. As a result of this, the original document and the duplication of important information are present in the field of the business activity as various media such as electronic data, a paper, a DVD, an IC card and a micro film. Then, it is required to provide a technique for managing locations and the life cycle (the number of duplication and the like) in an integrated fashion, without the medium type such as the electronic data and the paper, by linking an original document of important information to all duplications thereof.

### BRIEF DESCRIPTION OF DRAWINGS

FIG. 1 is a diagram illustrating an example of a configuration of a document management system of a first embodiment.

FIG. 2 is a diagram illustrating an example of a data configuration of a management file of first and second embodiments.

FIG. 3 is a diagram illustrating an example of a data flow, i.e. processing of the document management system of the first embodiment.

FIG. 4 is a diagram illustrating an example of a configuration and an operation of an OCR scanner device of the first embodiment.

FIG. 5 is a diagram illustrating an example of a configuration and an operation of an entry device and a filing device of the first embodiment.

FIG. 6 is a diagram illustrating an example of a configuration and an operation of a security operation device of the first embodiment.

FIG. 7 is a diagram illustrating an example of a table held by a management DB of the first embodiment.

FIG. 8 is a diagram illustrating an example of a configuration and an operation of a host system device of the first and second embodiments.

FIG. 9 is a diagram illustrating an example of a configuration and an operation of a security operation device of the first embodiment.

FIG. 10 is a diagram illustrating an example of a configuration and an operation of a policy management device of the first embodiment.

FIG. 11 is a diagram illustrating an example of a configuration and an operation of a security operation device of the first embodiment.

FIG. 12 is a diagram illustrating an example of data held by a policy storage unit of the first embodiment.

FIG. 13 is a diagram illustrating an example of a data configuration of a document attribute conversion profile of the first embodiment.

FIG. 14 is a diagram illustrating an example of a dada configuration of a policy reference file of the first embodiment.

FIG. 15 is a diagram illustrating an example of a configuration of a document management system of the second embodiment.

FIG. 16 is a diagram illustrating an example of a table held by a management DB of the second embodiment.

FIG. 17 is a diagram illustrating an example of a configuration and an operation of a policy management device of the second embodiment.

FIG. 18 is a diagram illustrating an example of a data configuration of a document attribute conversion profile of the second embodiment.

FIG. 19 is a diagram illustrating an example of a dada configuration of a policy reference file of the second embodiment.

FIG. 20 is a diagram explaining one effect achieved by the document management system of the first and second embodiments.

FIG. 21 is a diagram explaining a problem in prior art.

### DETAILED DESCRIPTION

In general, according to one embodiment, a document management system in the embodiments, includes an information acquisition unit that acquires a management ID which is identification information of original document data which is digital data of a paper document, or identification information of duplication data of original document data, acquires, using the management ID, document type information which is information associated with a type of the paper document from a storage unit, and outputs the document type information. The document management system in the embodiments of the invention, includes a policy selection evaluation unit that acquires operation information which is information for identifying a type of operation for original document data or duplication data, user information which is information associated with a user, and the document type information, selects policy information defining an operation extent of user based on the document type information, and evaluates whether or not that a user defined in the user information is authorized to perform an operation defined in the operation information in accordance with a definition of the selected policy information.

The embodiments will be explained by reference to the accompanying drawings below. Note that each device described below may be implemented, for each device, in any configuration where a hardware configuration or a hardware resource and a software resource are cooperated. As a software resource in the cooperation configuration, a program installed into a corresponding device from a network or a storage medium in advance and intended to allow the corresponding device to implement functions is used.

While, in each following described embodiment, an example which is described in a description form by reference to the XACML V2.0 indicated in non-patent reference document 1 associated with a document where a format of a rule (policy) relating to the authorization of the above described general reference and modification is defined, is explained, the description form may be implemented in any form. In the description examples of the embodiments, an indication of a composition element that is irrelative to the essence of the invention, among a name space, an attribute, an element and the like, is omitted.

### First Embodiment

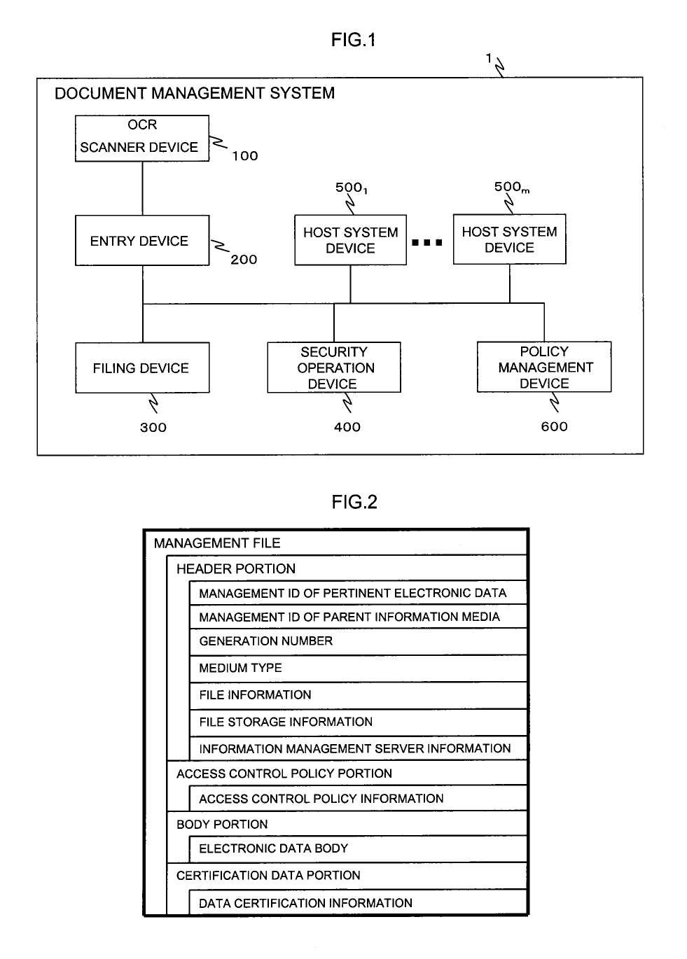

First, terms, an overview and the like as premises for explaining a document management system will be described. FIG. 1 is a schematic diagram illustrating a configuration of a document management system of each embodiment.

The document management system 1 includes an OCR scanner device 100 that reads an original document (paper document) to convert it into image data, recognizes character information from the image data to generate text data which is digital data, and evaluates and sets a document type.

The document management system 1 includes an entry device 200 that displays the image data and recognized text data and supports correction and supplement operation of the text data so as to generate original document data.

Furthermore, the document management system 1 includes a filing device 300 that stores the original document data, and a security operation device 400 that unities management of duplications of information media derived from the original document data of the document.

The document management system 1 includes a policy management device 600 that holds policy data of the document management and evaluates permission/prohibition of the document operation based on a request condition of an operation for the document, and host system devices 500₁-500ₘ (hereafter refer to as “host system device 500”) that request an operation for the document. Each of these devices has a configuration for allowing communication each other.

As types of the document operation requested by the host system device 500, there are the viewing, the electronic duplication, the printing on a paper, the deletion and the like of the original document data, and the viewing, the electronic duplication, the printing, the deletion, the disposal and the like of a duplication duplicated from the original document data by the electronic duplication, the printing, the scanning processing. The duplication includes various information media such as an electronic file, a paper and a CD-ROM.

As a result of the matter, the host system device 500 may be implemented as a device which can input an operation request to an information medium such as an electronic data and a paper, and is implemented as various devices such as a mobile phone, a personal computer (PC), a multi function printer, a printer, a copy machine/scanner, a shredding machine, a micro file reader, a DVD reader or a multi drive according to a using medium, so as to operates with a security operation device 400.

The document management system 1 assigns one unique management identification (ID) for identifying the above described information medium to each information medium, and connects the creation, the disposal, the interrelationship (the system or the medium type) and the situation relating to the medium utilization to the original document based on the management ID, so as to unity the system management.

When the information medium which is output by duplicating the original document data is electronic data, the document management system 1 may convert the electronic data into an electronic file of a file formant including the management ID. The electronic file after the conversion is called as a “management file”.

Here, data included in the management file will be explained by reference to FIG. 2. The management file includes header information including the management ID and attribute information, a access control policy and identification information for the management file, in addition to an electronic data body which is target information. The management file is configured to include a header portion, a access control policy portion, a body portion and an authentication data portion as shown in an example of FIG. 2.

The header portion is configured to include a management ID of the electronic data, a management ID of a parent information medium, a generation number, a medium type, file information, file storage information and information management server information. Note that the header portion is not limited to the configuration.

For example, as the management ID of the parent information medium, a management ID of the original electronic data on the duplication of the electronic data, a management ID of the original electronic data on the printing the electronic data and the outputting a paper medium, or a management ID assigned to a paper medium on the digitization of the paper medium by scanning may be adopted.

The generation number indicates a generation value which indicates, taking the original document data entered in the filing device 300 of document management system 1 for the starting point, that what number generation is the management file duplicated from the original document data on the system relationship managed as a parent, a child, a grandchild and the like. For example, assuming that a generation number of the management file as a parent is “1”, a generation number of a child information medium corresponding to the duplication of the file is “2” and a generation number of a grandchild information medium corresponding to the duplication of the child information medium. Note that the expression form of the generation number is not limited to that.

The file information includes a file format of the electronic data, a file size, creator information of the electronic data, date and time information of the creation and location information of the creation.

The file storage information includes information indicating whether or not that the electronic data body stored in the body portion is encrypted, and the file storage information further includes information in connection with the cryptographic algorithm, a cryptographic key and a cryptographic module when the electronic data body is encrypted.

The information management server information is information for identifying a MAC address and an IP address of the security operation device 400, a URI and the authentication data portion. As information for identifying the authentication data portion, it may be in a form that stores cryptographic key information or a certificate of the cryptographic key.

The access control policy portion stores access control policy information in connection with the terms of use, and the access control policy information describes electronic file processing for permission/prohibition on the basis of a use condition of electronic data such as extent information e.g. an available term of the electronic file, an available location thereof and an organization thereof, a network environment, a user, available device information and the number of times for use.

The body portion stores the electronic data body or cryptographic data generated by the cryptographic processing of the electronic data.

The authentication data portion stores authentication data information whereby the header portion, the access control policy portion and the body portion undergo the cryptographic processing of the security operation device 400. The data identification information may adopt a digital signature using the public key cryptosystem such as the Digital Signature Algorithm (DSA), the Rivest-Shamir-Adleman Scheme (RSA) and the Elliptic Curve DSA (ECDSA), or the Message Authentication Code (MAC) using a hash function or a common key cryptosystem, but is not limited thereto.

The above descriptions are provided as premises for explaining a document management system. The designation “document management system” indicating the present system may be changed to an “information management system”, an “information property management system” as appropriate, and each designation of the devices may be replaced with a designation applied to the usage. Likewise, terms “information”, “data” and “ID” in the designation may be replaced with a term applied to the usage.

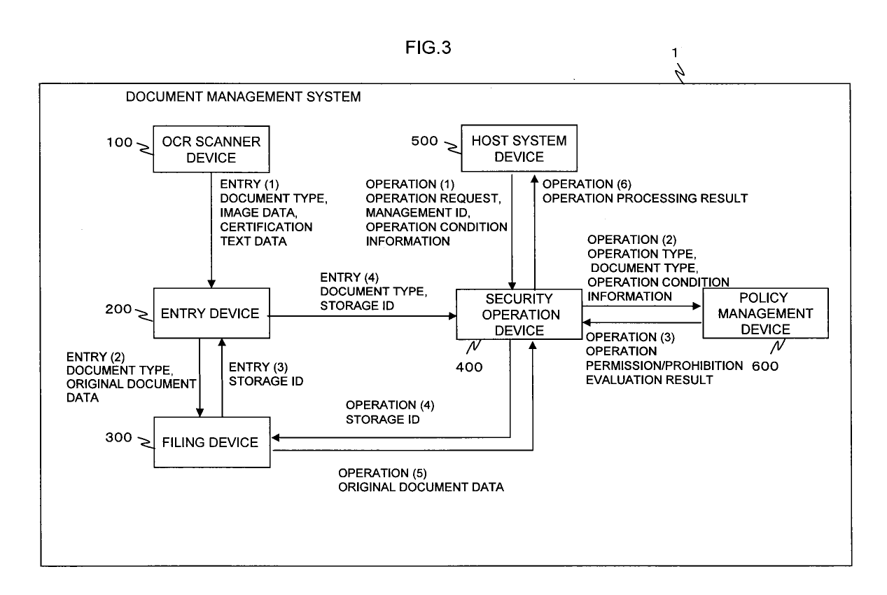

FIG. 3 is a diagram illustrating an example of a data and processing flow among the devices in the document management system 1. The term “ENTRY” illustrated in FIG. 3 indicates the entry processing flow of data and each ID, and the processing proceeds in order of a number in the parentheses. The term “OPERATION” illustrated in FIG. 3 indicates the processing flow in response to the reception of an operation request, such as the viewing and the electronic duplication of the original document data, described above from a user, and the processing proceeds in order of a number in the parentheses. These processing will be explained in detail below in each device.

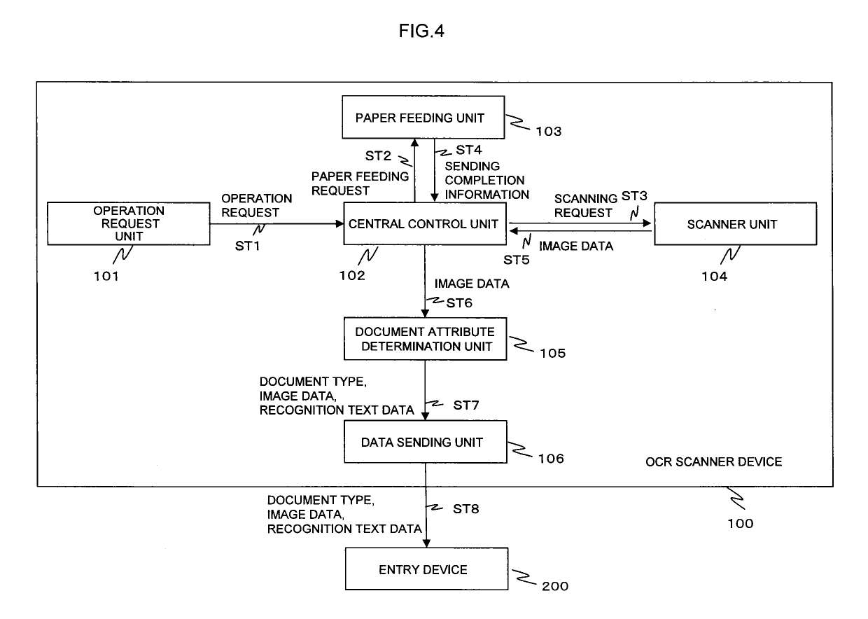

First, the detailed operation for entry the original document in the document management system 1 will be explained by reference to FIGS. 4 to 6.

An operation request unit 101 of the OCR scanner device 100 sends a read request of document to a central control unit 102 (ST1).

The central control unit 102 receives the read request of document from the operation request unit 101, and sends a paper feeding start request of document to a unit 103 (ST2). The central control unit 102 sends a scanning processing start request of document to a scanner unit 104 after the paper feeding processing start request of document to the paper feeding unit 103 (ST3).

The paper feeding unit 103 receives the paper feeding processing start request of document from the central control unit 102, starts the paper feeding processing to read out the document with the scanner unit 104, and sends, after the processing, feeding completion notice to the central control unit 102 (ST4).

The scanner unit 104 receives the scanning processing start request of document from the central control unit 102, generates image data that is the digital data of the document in conjunction with the paper feeding operation of the paper feeding unit 103, and sends the generate image data to the central control unit 102 (ST5). When a read error occurs, the contents of the error is sent to the central control unit 102.

The central control unit 102 receives the feeding completion notice from the paper feeding unit 103 and the image data from the scanner unit 104, sends the image data to the document attribute evaluation unit 105, and sends a document type evaluation request of the image data (ST6). The scanning processing start request of document to the scanner unit 104 may be send from the paper feeding unit 103 on the congress of the paper feeding.

The document attribute evaluation unit 105 receives the image data of the document from the central control unit 102, analyzes a paper size and mentioned contents of the document, generates text data (hereafter refer to as “recognition text data”), and evaluates a document type. The document type is classification information which may be sorted out according to the difference of handling rules or operation flows of a document such as a catalog, a specification, a contract and a identification form.

The method of analyzing mentioned contents of a document or the method of evaluating a document type may be implemented by a method of performing the character analyzing from image data and evaluating that on the basis of a title of the document or a keyword, a method of analyzing a document reference number and evaluating that, or a method of evaluating a layout pattern of document such as a frame border. When an optical tag such as the bar code, the two-dimensional code, the color code and the stealth bar code, or an electronic tag such as RFID, is attached to the document, the document type may be evaluated on the basis of the information stored in the tag.

Note that, since the bar code, the tag, the RFID and the like describe above are in a form that is on the basis of the character information such as the arrangement of numbers, the concept of the character information includes the bar code and the like. Any method of sorting out the document types from the image data or any combination of those may be adopted.

The document attribute evaluation unit 105 sends the image data, the recognition text data and the evaluated document type to a data sending unit 106 (ST7). Note that the general technique that disclosed in, for example, Japanese Laid-open Patent Publication No. 2003-168073 and Japanese Laid-open Patent Publication No. 2003-168074 may be applied to the character recognition or the document type evaluation.

The data sending unit 106 receives the image data, the recognition text data and the evaluated document type from the document attribute evaluation unit 105, and sends the image data, the recognition text data and the document type to the entry device 200 (ST8).

An entry management unit 201 in the entry device 200 is a functional unit for managing general correction and supplement operations and includes an entry management DB 2011. The entry management DB 2011 associates the image data, the recognition text data and the document type with one another sent from the data sending unit 106, to temporarily store these, and associates corrected text data from the edition support unit 202 (hereafter refer to as “corrected text data”) with those to temporarily store these.

The edition support unit 202 is a functional unit for supporting the recognition, the correction and the supplement operations of the character data by a data correction operator (a puncher). When the character recognition by the OCR scanner device 100 has an error or the recognition text data includes a defect, it is necessary to correct the recognition text data or to perform data supplement thereto.

The edition support unit 202 the image data and the recognition text data corresponding to the image data simultaneously by using the display means and the input means of the entry device 200, and supports the correction and supplement operations of the character string data by the puncher. By allowing the entry management DB 2011 to hold a table where identification information of the puncher and the document type are associated each other, the entry management unit 201 may control so as to allow a specific puncher to perform the correction and supplement operations of data of a specific document type. That may control so as to allow a specific puncher not to perform the correction and supplement operations of data of a specific document type.

The entry management unit 201 of the entry device 200 receives the document type, the image data and the recognition text data from the OCR scanner device 100 (ST8), and associates those data with one another to temporarily store those in the entry management DB 2011. The entry management unit 201 sends, in response to the request from the edition support unit 202, the image data and the recognition text data to the edition support unit 202 (ST9).

The support of the edition support unit 202 allows the puncher to compare the displayed image data with the displayed recognition text data to correct the character string data wrongly recognized by the OCR scanner device 100 to right data. The corrected text data is sent to the entry management unit 201 (ST10) and held in the entry management DB 2011.

A filing control unit 301 of the filing device 300 acquires the image data, right text data (which is corrected text data when the correction and supplement are required, and is the recognition text data when the correction and supplement are not required) and the document type (ST11), and associates these with one another to allow the original document data storage unit 302 to hold these (ST12). Hereafter, the image data and the right text data are called as “original document data”. The filing control unit 301 acquires the document type and storage location information at the time that the original document data is stored in the original document data storage unit 302, and sends these as a storage ID to the entry device 200 (ST13).

The entry control unit 201 receives the storage ID from the filing device 300, and sends the storage ID and a document type of the document to the security operation device 400 so as to request the document entry processing (ST14).

A communication control unit 401 of the security operation device 400 receives, from the entry device 200, the document type and the storage ID along with the document entry processing request, and sends the document type and the storage ID to the security control unit 402 (ST15).

The security control unit 402 receives the document type and the storage ID from the communication control unit 401, sends the document type, the storage ID the medium type and the location to the management DB control unit 403 (ST16), and request the entry into the management DB 404 (ST17). Since the medium type at the sending is the original document data of the document, the medium type is “electronic data”. Since the location is the original document data, that is a “filing device”.

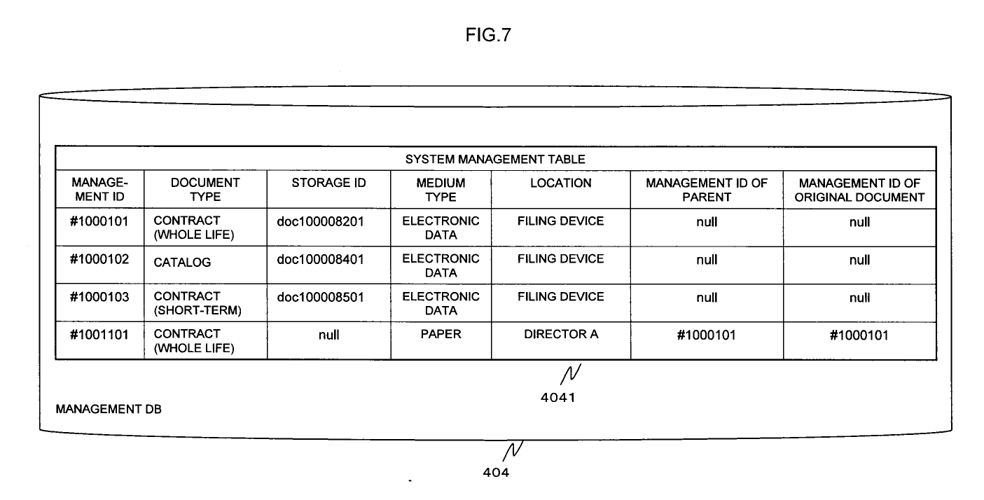

The management DB control unit 403 receives the document type, the storage ID and the medium type from the security control unit 402 (ST16), issues a management ID identifying the document, and associates the document type, the storage ID, the medium type and the location with the management ID to entry these in the management DB 404 (ST17). FIG. 7 is a diagram illustrating a data configuration of data entered in the management DB 404. The management DB 404 associates data with one another and stores the data using the system management table 4041. As shown in FIG. 7, the system management table 4041 includes each data of the management ID, the document type, the storage ID, each information of the medium types, the location, the parent management ID and the original document management ID. The location indicates the location and the owner of the original document data or the duplication thereof. The parent management ID indicates the management ID of the information medium which is a master of the information medium indicated by the management ID. The management ID of the original document indicates the management ID of the original document data which is an original from which the duplication is derived by the repetition of duplication such as the electronic copying, the printing, and the scanning. For example, when the duplication (management ID: #1001101) is generated by printing the original document data (management ID: #1000101) of the contract (whole life) shown in FIG. 7 on a paper, the parent ID becomes “#1000101” and the management ID of the original document becomes “#1000101”. The management DB control unit 403 sends, after the completion of the data entry into the management DB 404, the management ID which is issued to the original document data of the document as a target, to the security control unit 402 (ST18).

The security control unit 402 receives the management ID from the management DB control unit 403, sends the processing result of the entry request of the entry device 200, including the management ID to the communication control unit 401, and requests a reply to the entry device 200 (ST19).

The communication control unit 401 sends the processing result information including the management ID to the entry device 200 (ST20). After that, the entry processing is completed.

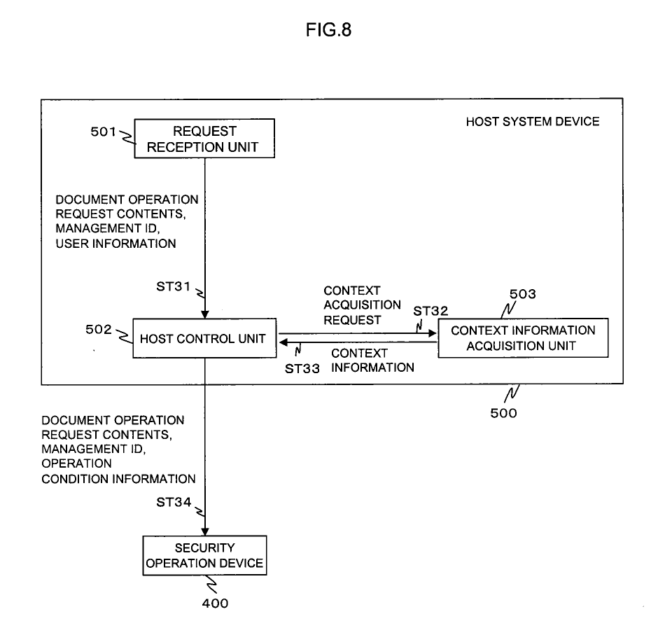

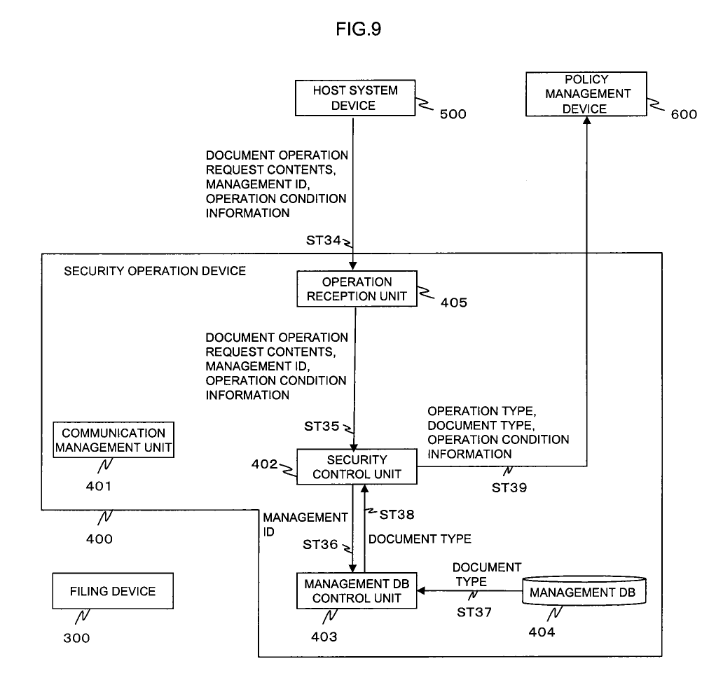

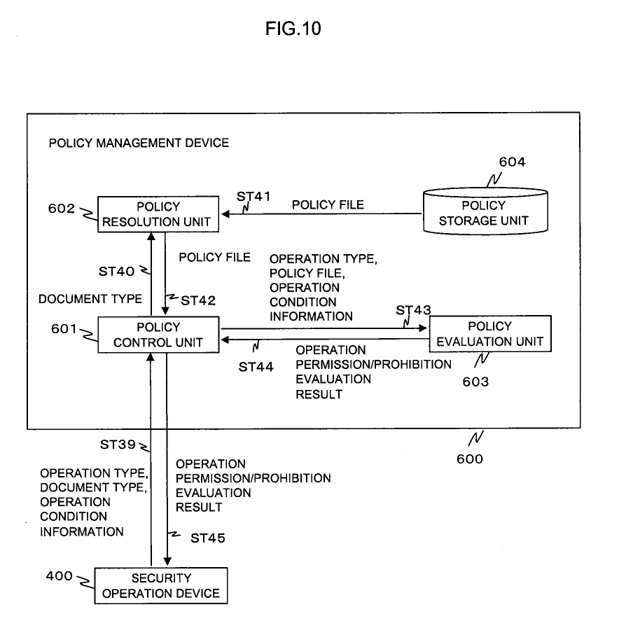

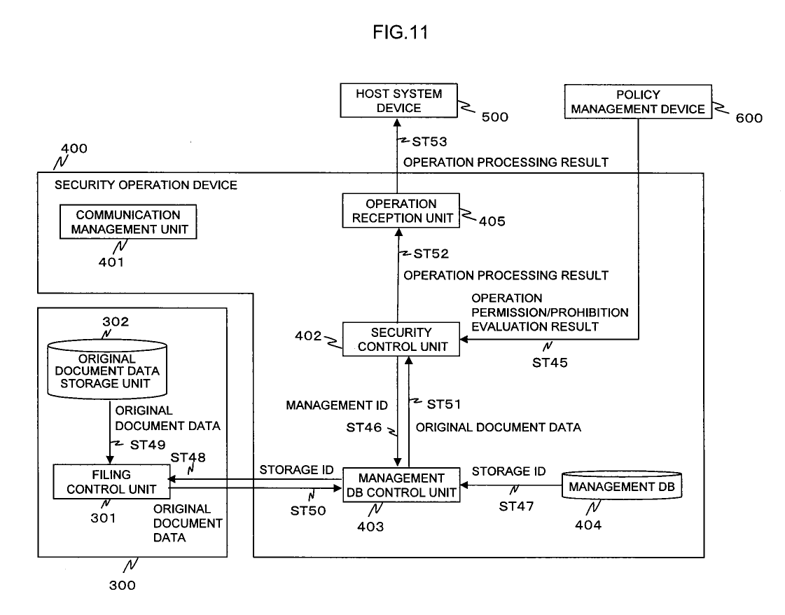

Next, the detailed operation for operating the document entered in the document management system 1 will be explained by reference to FIGS. 8 to 11.

When an operation request for the document to which a management ID is assigned, is input on a request reception unit 501 of the host system device 500, the request reception unit 501 sends the document ID of the document, document operation request contents including information identifying a operation type to the original document data or the duplication data, and user information in connection with the user who performs the request, to the host control unit 502 (ST31). The user information includes information needed for the permission/prohibition evaluation of the document operation, such as information for identifying an individual, e.g. an employee number, information for identifying an affiliated department, and attribute information indicating an executive or a regular employee. When the duplication is conducted, the user information includes information of all users who receive the duplication.

The host control unit 502 receives the management ID and the document operation request contents from the request reception unit 501, and sends the acquisition request of the context information to the context information acquisition unit 503 (ST32).

The context information acquisition unit 503 acquires, in response to the context information request from the host control unit 502, context information in connection with the host system device 500, such as an IP address or a MAC address, from related functions of the operating system, and sends it to the host control unit 502 (ST33). On the document management in the document management system 1, when a connection domain such as the IP address or the MAC address, or the authorization advisability of document operation is not required, the context information acquisition unit 503 and ST32-ST33 may be omitted. The authorization advisability of document operation using the connection domain is effectively applied to the case that the printing using the LAN connection on the seventh floor in the headquarters building is allowed and no duplication using the wireless LAN connection is allowed, for example. The context information relates to a device of the host system device 500 and identifies a user since the host system device 500 is used by the user. Therefore, the context information is included in the information in connection with the user.

The host control unit 502 sends the operation request contents, the management ID, and the operation condition information to the security operation device 400 (ST34). The operation condition information includes the user information, the context information, and information needed for the document operation in the document management system 1.

An operation reception unit 405 in the security operation device 400 receives the document operation request contents, the management ID and the operation condition information from the host system device 500, sends the document operation request contents, the management ID and the operation condition information to the security control unit 402, and request the document operation processing to it (ST35).

The security control unit 402 receives the document operation request contents, the management ID and the operation condition information from the operation reception unit 405, sends the management ID to the management DB control unit 403, and requests it to reply the document type of the document which is managed by using the management ID (ST36).

The management DB control unit 403 receives the sending request of the document type including the management ID from the security control unit 402, searches the management DB 404 for the management ID, and acquires the associated document type (ST37). The management DB control unit 403 sends the acquired document type to the security control unit 402 (ST38).

The security control unit 402 receives the document type from the management DB control unit 403, sends the operation type included in the document operation request contents, the document type and the operation condition information to the policy management device 600, and requests the permission/prohibition evaluation of the operation to the management type on the operation condition information (ST39). The operation type is an identification code indicating an operation type to the document of the designated management ID, such as the viewing and electronic copying of the original document data, the printing, the deletion, the electronic copying derived from the original document data, the duplication (electronic copying, printing, scanning) from the printing, the electronic file and document, and the deletion and disposal of the duplication of the original document data which is output in a medium e.g. a CD-ROM.

A policy control unit 601 of the policy management device 600 receives the operation permission/prohibition evaluation request including the operation type, the document type and the operation condition information, sends the document type to the policy resolution unit 602, and request a section of a policy file (policy information) corresponding to the document type (ST40).

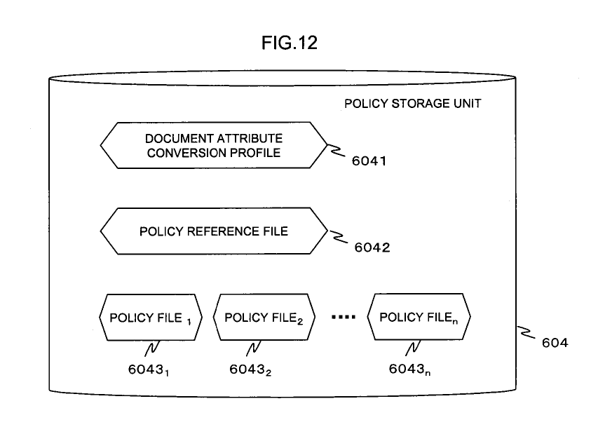

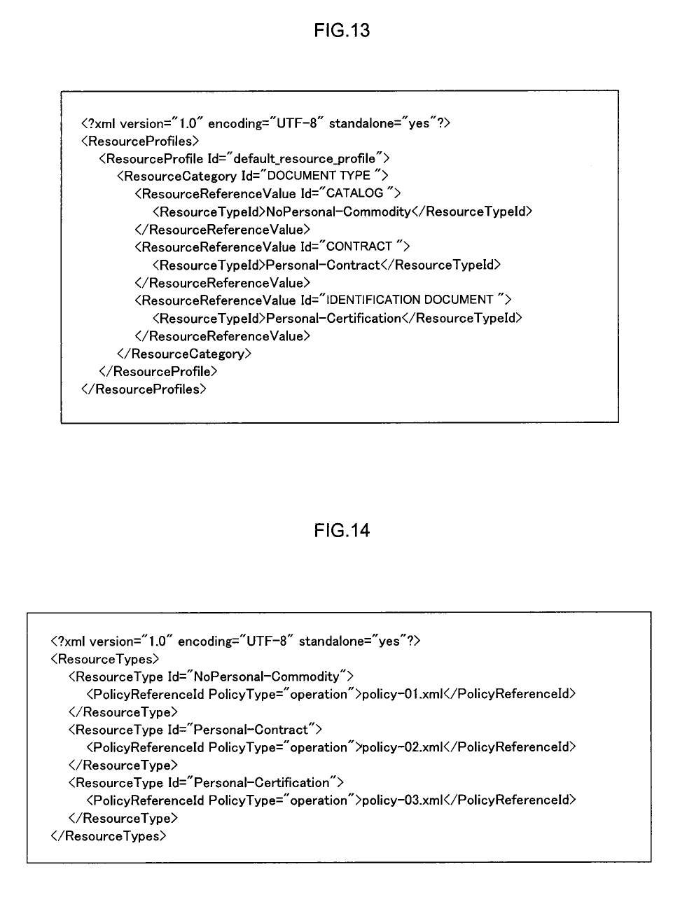

The policy resolution unit 602 receives the policy file section request including the document type from the policy control unit 601, and refers to a document attribute conversion profile 6041 and a policy reference file 6042 stored in the policy storage unit 604 so as to select the policy file corresponding to the document type (ST41). An example of data held in the policy storage unit 604 is shown in FIG. 12. The document attribute conversion profile 6041 manages the relation between a document type and a policy identifier. An example of a data configuration of the document attribute conversion profile 6041 is shown in FIG. 13. In the FIG. 13, for example, when the document type is “catalog”, a policy designated by a policy identifier “NoPersonal-Commodity” is a reference description. The policy reference file 6042 manages the relationship between the policy identifier and the policy file 6043. An example of a data configuration of the policy reference file 6042 is shown in FIG. 14. FIG. 14 shows, for example, that an entity of the policy file designated by the policy identifier “NoPersonal-Commodity” is “policy-01.xml”.

An operation of the policy file selection when the document type is a “contract”, will be explained below.

(a) A policy resolution unit 602 refers to the document attribute conversion profile 6041 via the policy storage unit 604, searches for a policy identifier of the document type corresponding to a “contract”, and acquires the policy identifier (ResourceTypeId) that is a “Personal-Contract”.

(b) The policy resolution unit 602 refers to the policy reference file 6042 via the policy storage unit 604, searches for a policy file (PolicyReferenceId) assigned by a policy identifier which is a “Personal-Contract”, and acquires the policy file 6043 “policy-02.xml” which deals with the “contract”.

(c) The policy resolution unit 602 sends the acquired policy file 6043 “policy-02.xml” to the policy control unit 601 (ST42).

The policy control unit 601 sends the policy file 6043 received from the policy resolution unit 602 and the operation type, operation condition information received from the security operation device 400 to the policy assessment unit 603 (ST43).

The policy assessment unit 603 performs the operation permission/prohibition evaluation under the operation condition in accordance with the description of the policy file 6043. The permission/prohibition evaluation performs the assessment, for example, in accordance with the specification disclosed in the non-patent document 1 discussed above. The description contents of the policy file 6043 is disclosed, for example, by the non-patent document 1 as the standard description specification with description samples. In the first embodiment, the policy file 6043 defines an operation extent of a user, i.e. the information about an available operation (unavailable operation) of the user.

The policy assessment unit 603 performs the evaluation in accordance with the policy file 6043, and sends the operation permission/prohibition evaluation result to the policy control unit 601 (ST44).

The policy control unit 601 sends the operation permission/prohibition evaluation result to the security operation device 400 (ST45).

Only when the operation permission/prohibition evaluation result received from the policy management device 600 indicates “permission”, the security control unit 402 of the security operation device 400 sends the management ID of the operation request to the management DB control unit 403, and requests the management DB control unit 403 to acquire the original document data corresponding to the management ID (ST46). When the operation permission/prohibition evaluation result indicates “prohibition”, the security control unit 402 informs the host system device 500 of operation prohibition via the operation reception unit 405.

The management DB control unit 403 receives the original document data acquisition request including the management ID from the security control unit 402, and searches the system management table 4041 of the management DB 404 for a storage ID associated with the management ID to acquire it (ST47). The management DB control unit 403 sends the storage ID to the filing device 300, and requests the sending the original document data entered by using the storage ID (ST48).

The filing control unit 301 of the filing device 300 receives the original document data sending request including the storage ID form the security operation device 400, and searches the original document data storage unit 302 for the original document data corresponding to the storage ID (ST49). The filing control unit 301 sends the original document data to the security operation device 400 (ST50).

The management DB control unit 403 sends the original document data received from the filing device 300 to the security control unit 402 (ST51).

The security control unit 402 receives the original document data from the management DB control unit 403, performs the processing corresponding to the operation type, and sends the operation processing result to the operation reception unit 405 (ST52). Note that the operation processing is performed in accordance with the operation type as below.

(a) When the operation type indicates the viewing of original document data, the security control unit 402 sends the original document data to the operation reception unit 405, and the operation reception unit 405 sends the original document data to the host system device 500.

(b) When the operation type indicates the electronic copying to be output as a management file where the duplication data of original document data is undergone the security protection, the security control unit 402 issues the management ID for the duplication data. The management DB control unit 403 enters the issued management ID into the system management table 4041 of the management DB 404, enters the management ID of the operation request into the parent management ID, and enters the management ID of original document corresponding to the parent management ID into the management ID of original document. Furthermore, the document type associated with the management ID of the operation request is entered, “electronic data” is entered as the medium type, and the user information included in the operation condition information from the host system device 500 is entered as the location. After that, the security control unit 402 generates the management file shown in FIG. 2, and sends it to the operation reception unit 405 as the operation processing result. The operation reception unit 405 outputs the management file to the device which controls the writing into the medium, so that the generated management file is copied into the medium designated by the user. When there are a plurality of received users, the operation is repeated the user number of times.

(c) When the original document data is printed on a paper, the security control unit 402 issues the management ID for the print material management, in the same manner as the above described (b), enters the management ID issued this time into the system management table 4041 of the management DB 404 via the management DB control unit 403, enters the original management ID of the operation request into the parent management ID, and enters the original document management ID corresponding to the parent management ID into the original document management ID. The document type associated with the management ID of the operation request is entered as a document type, “paper” is entered as a medium type, and the user information included in the operation condition information from the host system device 500 is entered as a location. After that, the security control unit 402 sends the issued management ID and the original document data to the operation reception unit 405 as the operation processing result. When there are a plurality of received users, the operation is repeated the user number of times. Note that an ID tag storing the management ID, such as an optical tag e.g. the bar code, the two-dimensional code, the color code and the stealth bar code, or an electronic tag such as RFID, is attached to the document data sent to the operation reception unit 405. The operation reception unit 405 outputs the original document data to which the management ID is attached to a predetermined image formation device to print is on a paper.

The operation reception unit 405 sends the operation processing result received from the security control unit 402 to the host system device, completing the processing (ST53).

When the operation type indicates the viewing of the original document data, ST48-ST50 may be omitted, and the security control unit 402 may receive the storage ID from the management DB control unit and may send the storage ID in place of the original document data to the host system device 500. The host system device 500 sends the storage ID to the filing device 300 and acquires the corresponding original document data. Likewise, when the original document data is output on a paper, the storage ID and the management ID mat be sent to the host system device 500, and the acquisition of the original document data and the attachment of the ID tag storing the management ID may be conducted out of the security operation device. These modifications may be applied to each of the following embodiments.

### Second Embodiment

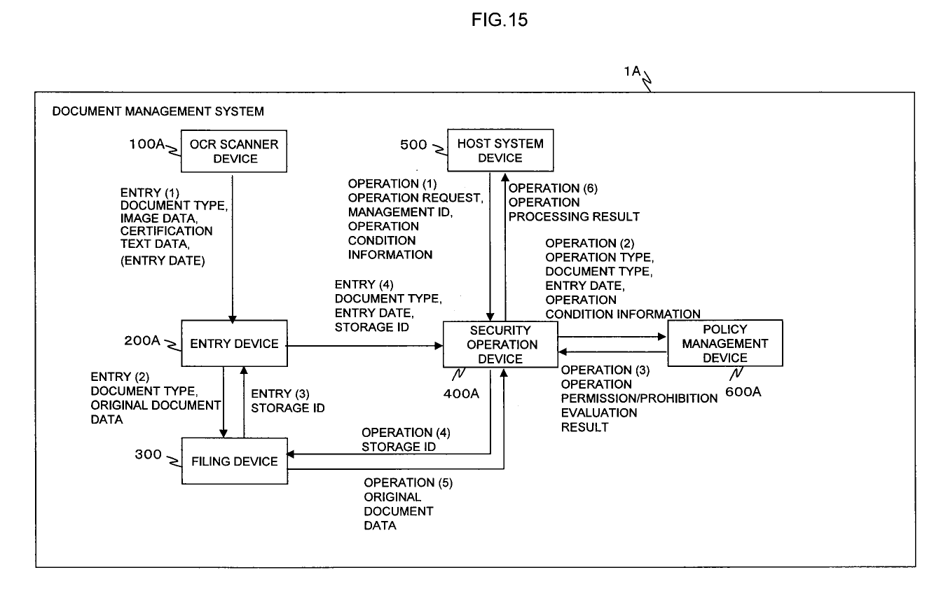

FIG. 15 is a schematic diagram illustrating a configuration of a document management system of a second embodiment, the same components in FIG. 3 are assigned to the same numerals respectively, the detail description thereof are omitted, and different components will be mainly described below.

The second embodiment is a modification of the first embodiment, where an entry date of a document is adopted as a condition of the policy selection in addition to the document type so that a policy appropriate to the entry data of document is selected even if the dealing with document based on the date is changed according to the law amendment, and the appropriate document management is conducted in the embodiment. The entry date may be the date when the original document data is stored in the filing device 300, the contract date on contract document, the date for the application or the issue date of catalog.

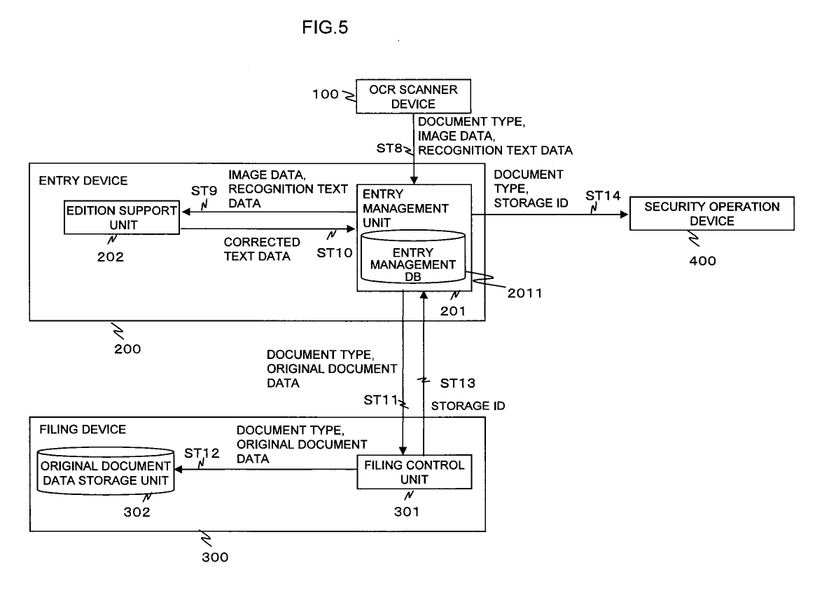

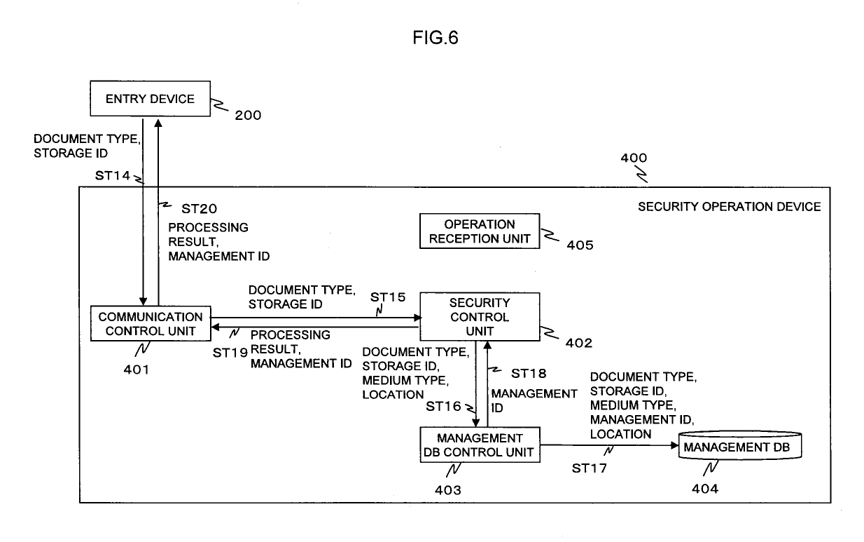

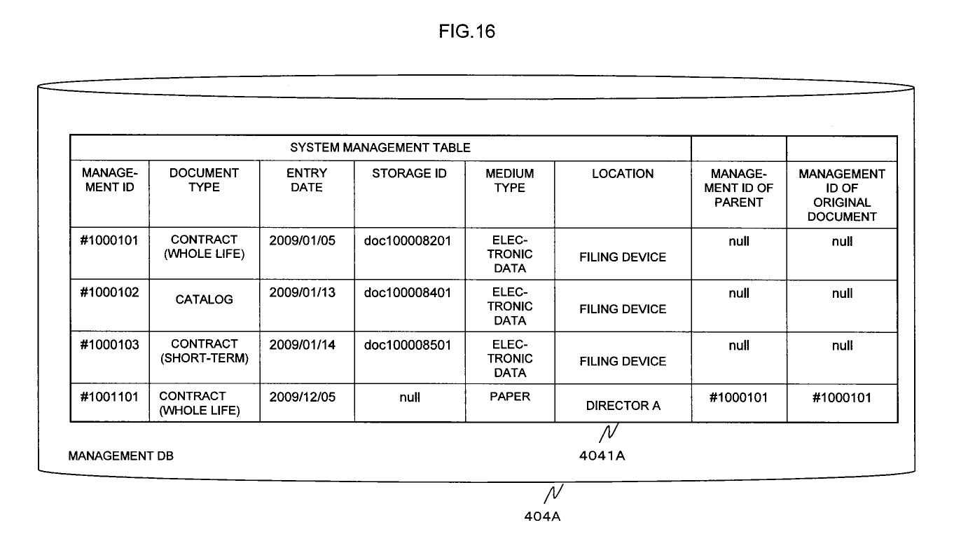

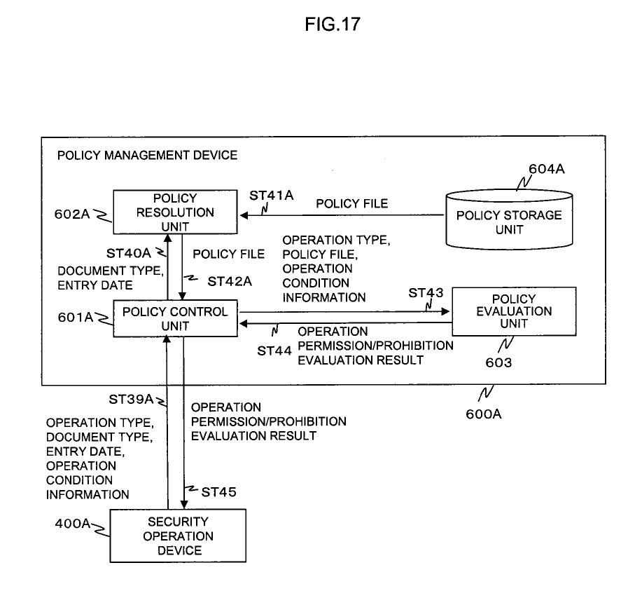

The document management system 1A will be explained in the second embodiment includes an OCR scanner device 100A, an entry device 200A, a filing device 300, a security operation device 400A, a host system device 500 and a policy management device 600A. While the entry processing of an original document in the second embodiment is almost conducted in the same manner as that of the first embodiment, the OCR scanner device 100A identifies fields of a contract date, an application date, and an issue date of a catalog, acquires the date as an entry date, and sends it to the entry device 200A (ST8 in FIG. 5). Note that the processing is not necessary when the entry date is a date of the storing the original document data in the filing device 300. The entry device 200A sends the entry date, in ST14 in FIG. 6, in addition to the document type and the storage ID. In the security operation device 400A, the entry date is sent from each unit in addition to the document type at ST15 to ST17, and is associated with the document type to be entered in a management DB (404A in the second embodiment). A configuration of management DB 404A of the embodiment is shown in FIG. 16.

While an operation of a document entered in the document management system 1A is conducted in the same manner as that of the first embodiment, the entry date is acquired and sent by each unit in addition to the document type at ST37 to ST39.

The processing in the policy management device 600A will be described below by reference to FIG. 17.

The policy control unit 601A of the policy management device 600A receives, from the security operation device 400A, an operation permission/prohibition evaluation request including the operation type, the document type, the entry date and the operation condition information, sends the document type and the entry date and the entry date to the policy resolution unit 602A, and request selection of a policy file corresponding to the document type (ST40A).

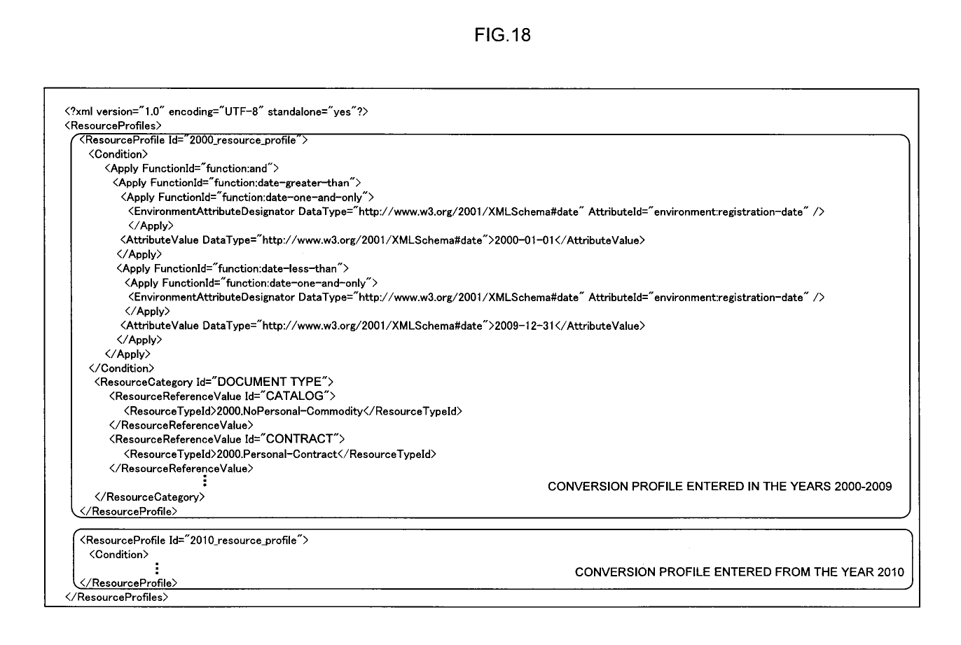

The policy resolution unit 602A receives the policy file section request including the document type and the entry date from the policy control unit 601A, and selects a policy file corresponding to the document type by referring to the document attribute conversion profile 6041A and the policy reference file 6042A stored in the policy storage unit 604A. The document attribute conversion profile 6041A manages the relation between the document type and entry date and the policy identifier. FIG. 18 shows an example of a data configuration of the document attribute conversion profile 6041A. In the example in FIG. 18, a condition of an entry date is defined in a condition tag and the following document type evaluation is conducted when the condition is met. In the description of the example of FIG. 18, when an entry date is equal to or larger than “2000/1/1” and is equal to or smaller than “2009/12/31”, a policy designated by the “2000. NoPersonal-Commodity”, “2000. Personal-Contract” and the like is referred to. For example, when the entry date of a document is “2009/01/13” and the document type is “catalog”, the policy designated by the policy identifier “2000.NoPersonal-Commodity” is referred to.

Note that “conversion profile entered in the years 2000-2009” indicates profiles managing the document type and the policy identifier where the documents have an entry date from “2000/1/1” to “2009/12/31”.

Then, “conversion profile entered from the year 2010” indicates profiles managing the document type and the policy identifier where the documents have an entry date is equal or later than “2010/1/1”.

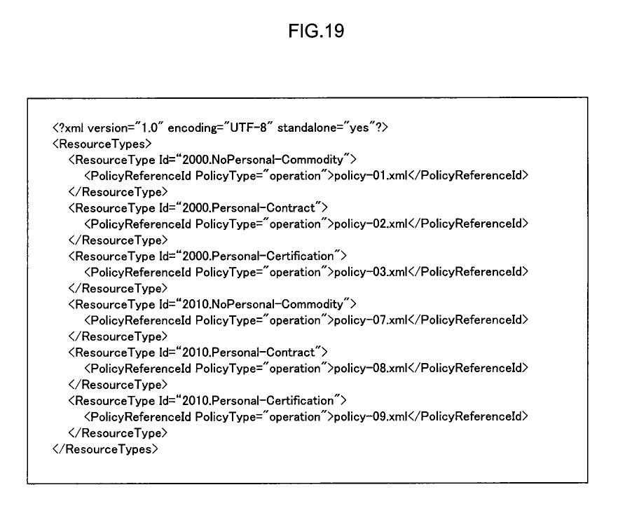

The policy reference file 6042A defines the relation between the policy identifier and the policy file 6043. FIG. 19 shows an example of a data configuration of the policy reference file 6042A. For example in FIG. 19, a policy file entity of the policy identifier “2000.NoPersonal-Commodity” is “policy-01.xml”. The processing of the policy file selection when the entry date is “2009/01/05” and the document type is “contract”, will be described below.

(a) The policy resolution unit 602A refers to the document attribute conversion profile 6041A via the policy storage unit 604A and assesses a conversion profile which deals with document having the entry date “2009/01/05”. In the case of FIG. 18, a profile where ResourceProfile Id is “2000_resource_profile” is assessed. Since the entry date “2009/01/05” is included in the term from 2000 to 2009 to meet the condition of the profile, the policy resolution unit 602A searches the profile for a policy identifier where a document type (ResourceReferenceValue Id) is “contract” to acquire ResourceTypeId of “2000. Personal-Contract”.

(b) The policy resolution unit 602A refers to the policy reference file 6042 (refer to FIG. 19) via the policy storage unit 604A, and searches PolicyReferenceId where the policy identifier is “2000.Personal-Contract” to acquire the policy file 6043 “policy-02.xml” which deals with “contract” (ST41A).

(c) The policy resolution unit 602A sends the acquired policy file 6043 “policy-02.xml” to the policy control unit 601A (ST42A).

The processing after that is the same as that of the first embodiment, ST43 to ST53.

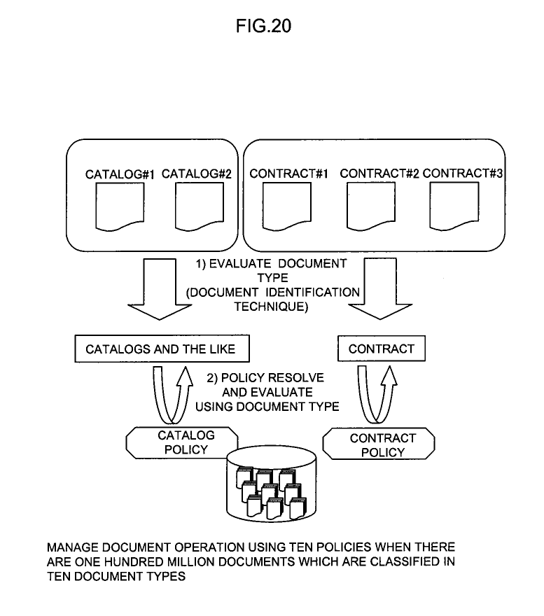

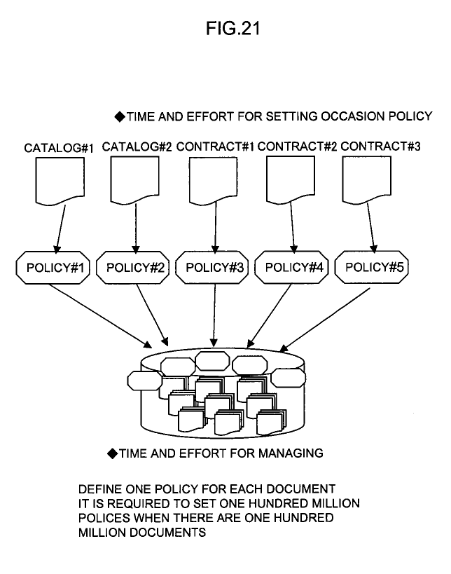

The effects of the document management system explained in the first and second embodiments will be described by reference to FIG. 20. The document management system of the first and second embodiments evaluates a document type such as a catalog and a contract based on a paper document, and sets a policy defined for each document type to the document so as to restrict an operation of a user. While one policy is conventionally defined for each document, the document management system of the first and second embodiments uses document types whose number is certainly less than the number of documents to define a policy for each document type, so as to facilitate the management of those and reduce the processing load of a system.

By using the document management system of the first and second embodiments, the management of the original document data and the duplication may be implemented whereby locations of the media thereof may be recognized. Therefore, in case of an event linked to the leakage of client information occurs, it becomes that easier to clarify the how and the route.

In the second embodiment, while a date associated the original document data as the entry date, in addition to the document type, is utilized to select the policy file, it is not limited to the date, and the “date” may be a “date and time” such as a “day of the week”, a “term”, a “time of day”, a “time” and a “period”. The entry day (entry date and time) associated with the original document data may be changed to a date and time of performing of an operation. In that case, the policy management device 600A acquires a current date and time from a system clock or an external server, for example, and selects a policy file by the above described processing using the acquired current date and time. Consequently, the second embodiment may be applied to the cases where the duplication of an original document is not authorized outside of business hours, or the internal rules defining prohibition of the duplication of an original document on a day off work or a national holiday are adopted, from the viewpoint of security for example.

The document catalog is relatively broadly divided into a “catalog”, a “contract” and the like in the first and second embodiments, but may be further divided into, for example in the case of the “catalog”, “catalog of a commodity A”, “catalog of a service in a commodity A” and the like. In the first and second embodiments, a policy may be hierarchically set to each type classification such as a large classification, a middle classification and a small classification.

The OCR scanner device 100 in the first and second embodiments, other than this form, may be configured to include a scanner device such as MFP, and a computer having an OCR function for converting (recognizing) character information described in image data into electronic data.

While the document type is associated with the policy file based on the description information in the XML form in the first and second embodiments, the state is not limited to that, and any form or processing form which clarifies the relationship may be applied to the state. While the policy file is selected by using two definition files of a document attribute conversion profile and a policy reference file in the first and second embodiments, the policy file may be selected by using one file where the document type and the policy file are directly associated with each other.

While a configuration providing each device except the host system device 500 is implemented in the document management system in the first and second embodiments, the configuration is not limited to that, and a configuration providing a plurality of entry devices 200 according to the number of punchers may be implemented or a configuration providing a plurality of devices as necessary from the view point of the load distribution, for example. Each function unit may be fixed to one of devices. For example, a configuration where a document attribute evaluation unit of the OCR scanner device is disposed within the entry device may be implemented.

Note that a information acquisition unit corresponds to the security operation device 400, 400A in the above described embodiments, and a policy selection evaluation unit corresponds to the policy management device 600, 600A. An original document data storage unit corresponds to the filing device 300 in the embodiments.

An image data conversion unit corresponds to the operation request unit 101, the central control unit 102, the paper feeding unit 103 and the scanner unit 104, a recognition unit corresponds to the document attribute evaluation unit 105 and the data sending unit 106, and a support unit corresponds to the entry device 200.

The policy management device 600, 600A in the embodiments may be provided as a evaluation unit for user operation including the acquisition unit, the policy selection unit and the policy evaluation unit. In the case of that, the acquisition unit corresponds to the policy control unit 601, 601A in the embodiments, and the policy selection unit corresponds to the policy resolution unit 602, 602A and the policy storage unit 604, 604A. A policy evaluation unit corresponds to the policy assessment unit 603 in the embodiments.

Moreover, the security operation device in the embodiments may be provided as a data output control device including an acquisition unit, a document type information unit and an output unit. In the case of that, the acquisition unit corresponds to the operation reception unit 405 of the embodiments, the document type information acquisition unit corresponds to the management DB control unit 403, and the output unit corresponds to the security control unit 402, the management DB control unit 403, the management DB 404 and the operation reception unit 405.

Note that the technique described in the embodiments may be distributed as a program for causing a computer to do that, stored in a storage medium such as a magnetic disk (a floppy (trademark) disk, a hard disk and the like), an optical disk (a CD-ROM, a DVD and the like), a magneto-optical disk (an MO) and a semiconductor memory.

The storage medium may be implemented in any type of medium which is able to store a program and is a computer readable medium.

An operating system (OS) operating in a computer on the basis of instructions of a program installed in the computer from a storage medium, a database management software or a middleware (MW) such as a network software may perform a part of each processing for implementing the embodiments.

Moreover, the storage medium in the embodiments of the invention is not limited to a medium independent of a computer, and includes a medium where a program transmitted from a LAN, the Internet and the like is downloaded and stored or temporarily stored.

The storage medium is not limited to one and the storage media may be applied to the embodiments when the processing thereof is implemented on the storage media, therefore adopting any type of medium configuration.

Note that the computer of the embodiments of the invention performs each processing in the embodiments on the basis of a program stored in a storage medium, and may be implemented in any type of configuration, such as one device for example a personal computer, and a system where a plurality of devices are connected to a network.

The computer in the embodiments of the invention is not limited to a personal computer, includes a processor controller, a microcomputer and the like included in a information processing equipment, and is a generic term used to refer to a equipment or a device that may implement functions in the embodiments of the invention.

While certain embodiments have been described, there embodiments have been presented by way of example only, and are not intended to limit the scope of the inventions. Indeed, the novel embodiments described herein may be embodied in a variety of other forms: furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document management system comprising:
an information acquisition unit that acquires a management ID which is identification information of original document data which is digital data of a paper document, or identification information of duplication data of original document data, acquires, using the management ID, document type information which is information associated with a type of the paper document from a storage unit, and outputs the document type information; and
a policy selection evaluation unit that acquires operation information which is information for identifying a type of operation for original document data or duplication data, user information which is information associated with a user, and the document type information, selects policy information defining an operation extent of user based on the document type information, and evaluates whether or not that a user defined in the user information is authorized to perform an operation defined in the operation information in accordance with a definition of the selected policy information.

2. A document management system according to claim 1, wherein
the information acquisition unit acquires information of a date and time associated with the original document data by using the acquired management ID, and output the information of a date and time, and
the policy selection evaluation unit acquires the information of a date and time output from the information acquisition unit, and selects policy information based on the document type information and the information of a date and time.

3. A document management system according to claim 1 or 2, wherein
the information acquisition unit acquires information of a current date and time and outputs the information of a current date and time, and
the policy selection evaluation unit acquires the information of a current date and time output from the information acquisition unit, and selects policy information based on the document type information and the information of a current date and time.

4. A document management system according to one of claims 1 to 3, further comprising:
an original document data storage unit that stores original document data, wherein
the policy selection evaluation unit further outputs a result of the evaluation, and
the information acquisition unit further acquires the result of the evaluation, and, when the result of the evaluation indicates that the user is allowed to perform the operation, acquires original document data corresponding to the ID from the original document data storage unit based on the management ID, and outputs original document data to a device for executing an operation defined in the operation information.

5. A document management system according to claim 4, further comprising:
an image data conversion unit that converts a paper document into image data;
a recognition unit that recognizes at least one of character information and ruled line information in the image data, converts the character information into text data, and associates document type information of the paper document with the image data and the text data based on at least one of the recognized character information and the recognized ruled line information; and
a support unit that simultaneously displays the image data and the text data which is converted by the recognition unit, and supports correction of text data including an error due to a recognition error by the recognition unit, wherein
the original document data storage unit acquires and stores one of the text data recognized by the recognition unit and the text data corrected by the support of the support unit, and the image data as the original document data, and
the information acquisition unit acquires information indicating a storage location of the original document data stored in the original document data storage unit, and the document type information, creates a record at least including these information, and attaches a management ID to the record to store it in the storage unit.

6. A user operation evaluation apparatus comprising:
an acquisition unit that acquires operation information which is one of information for identifying a type of operation for original document data that is digital data of a paper document and information for identifying a type of operation for duplication data of original document data, user information which is information associated with a user, and document type information which is information associated with a type of a paper document;
a policy selection unit that selects policy information defining an operation extent of a user based on the document type information; and
a policy evaluation unit that evaluates, based on the policy information selected by the policy selection unit, whether or not a user defined by the user information is authorized to perform an operation defined by the operation information.

7. A data output control apparatus comprising:
an acquisition unit that acquires an management ID which is one of identification information of original document data that is digital data of a paper document and identification information of duplication data of original document data, user information which is information associated with a user, and operation information which is information for identifying a type of operation for original document data or duplication data;
a document type information acquisition unit that acquires document type information which is information associated with a type of the paper document from a storage unit by using the management ID, and outputs the document type information; and
an output unit that, when it is evaluated that a user defined by the user information is authorized to perform an operation defined by the operation information based on the document type information output from the document type information acquisition unit, and when the output unit receives the evaluation result, acquires original document data corresponding to the management ID from a storage unit, and outputs the original document data to a device which performs an operation defined by the operation information.

8. A document management method, wherein a computer:
acquires a management ID which is one of identification information of original document data that is digital data of a paper document and identification information of duplication data of original document data, acquires document type information which is information associated with a type of the paper document from a storage unit by using the management ID, and outputs the document type information; and
acquires operation information which is information for identifying a type of operation for original document data or duplication data, user information which is information associated with a user, and the document type information, selects policy information defining an operation extent of a user based on the document type information, and evaluates whether or not a user defined by the user information is authorized to perform an operation defined by the operation information in accordance with the selected policy information.

9. A document management program that causes a computer to perform a process comprising:
acquiring a management ID which is one of identification information of original document data that is digital data of a paper document and identification information of duplication data of original document data, acquiring document type information which is information associated with a type of the paper document from a storage unit by using the management ID, and outputting the document type information; and
acquiring operation information which is information for identifying a type of operation for original document data or duplication data, user information which is information associated with a user, and the document type information, selecting policy information defining an operation extent of a user based on the document type information, and evaluating whether or not a user defined by the user information is authorized to perform an operation defined by the operation information in accordance with the selected policy information.
